(19) United States
(12) Patent Application Publication
(10) Pub. No.: US 2007/0158474 A1
(43) Pub. Date: Jul. 12, 2007

(54) Dispensing adapter

(76) Inventor: Herbert Berger, Grossschonau (AT)

Correspondence Address: HENRY M FEIEREISEN, LLC, 350 FIFTH AVENUE, SUITE 4714, NEW YORK, NY, 10118, US

(21) Appl. No.: 11/563,370

(22) Filed: Nov. 27, 2006

Related U.S. Application Data
(63) Continuation-in-part of application No. PCT/IB05/01507, filed on Apr. 21, 2005.

(30) Foreign Application Priority Data
May 25, 2004 (DE) 20 2004 008 335.3
May 25, 2004 (DE) 20 2004 008 339.6

(51) Int. Cl. B05B 1/18; B05B 1/26

(52) U.S. Cl. 239/567; 239/558; 239/601; 239/337

(57) ABSTRACT

In a dispensing adapter (1) for cartridges, cans or tubes adapted for storing and metered dispensing of highly viscous materials, in particular liquids such as adhesives, sealants, foamed-in plastics or the like, through a nozzle head, the nozzle head of the metering nozzle (6, 17) has several spaced-apart openings (7, 25) for discharge of the material.

### CROSS-REFERENCES TO RELATED APPLICATIONS

This application is a continuation-in-part of prior filed copending PCT International application no. PCT/IB2005/001507, filed April 21, 2005, which designated the United States and has been published but not in English as International Publication No. WO 2005/115635 and on which priority is claimed under 35 U.S.C. §120, and which claims the priority of German Patent Applications, Serial No. 20 2004 008 335.3, filed May 25, 2004, and 20 2004 008 339.6, filed May 25, 2004, pursuant to 35 U.S.C. 119(a)-(d).

### BACKGROUND OF THE INVENTION

The invention relates to a dispensing adapter for cartridges, cans or tubes for storing and dispensing highly viscous substances, in particular liquids like adhesives, sealants, foamed-in plastics and the like, through a nozzle head.

Such dispensing adapters are used in private homes as well as in industrial applications, in particular in construction. Conventional dispensing adapters are known which are either non-releasably connected with the container holding the material to be applied or which can be, as desired, placed on or screwed on a corresponding container.

In addition to the commercially available conical shape made as a single piece, two- or multi-part dispensing adapters are known. The section of the adapter facing the container is either provided with a flexible coupling member, or the various parts are connected via an articulated joint, so that the orientation of the end piece, i.e., the nozzle head, from the tip of which the material is dispensed through an opening, can be adjusted. This makes it possible to also reach areas which are difficult to access, for example undercuts or interior corners.

DE 296 00 052 U1 discloses a container with a nozzle arrangement, where an extension member with a flexible section is employed between the container and the nozzle at the end. The flexible section has the form of an expansion bellow, allowing the rigid nozzle placed on the extension member to be pivoted.

DE 22 15 931 U1 discloses a two-part dispensing adapter whose parts are connected with one another in such a way that the angle between their longitudinal axes can be changed by moving the parts relative to one another. In one embodiment, both parts can be rotated relative to one another in a plane at an angle to their respective longitudinal axes. In another embodiment, the two parts are connected via a ball joint.

One embodiment of the dispensing adapter according to the invention provides, in addition or instead of the conventional central opening, several spaced-apart openings or punch-outs in the exterior surface of the metering nozzle. These are arranged as closed rated break points which can be selectively opened. The user can then, as desired, unblock the preferred openings by pressing against the outer jacket at the corresponding rated break points. The number of openings and/or provided rated break points can be arbitrary. As needed, a corresponding number of openings is unblocked at the rated break points by pressing inward.

The arrangement of the openings in the outer jacket of the metering nozzle can also be varied. These are preferably arranged in form of a ring or in the longitudinal direction along the outer jacket of the metering nozzle. Openings or rated break points of different sizes and shapes are provided to enable a large number of applications of the dispensing adapter according to the invention. In addition, instead of a round cross-section, the openings can have also an elliptical or oval cross-section or a triangular, rectangular or rhombic cross-section. Preferred is a combination of openings and/or rated break points having different sizes and shapes which are uniformly distributed over the outer jacket of a metering nozzle.

Advantageously, a plurality of punch-outs or openings in the nozzle head not only increases the dispensing velocity, but also ensures a uniform distribution of the material, because the material or the substance is simultaneously discharged in different directions into the gap to be filled.

In addition to arranging the openings or rated break points laterally in the jacket section of the metering nozzle to allow many different applications of the dispensing adapter, the adapter can also still be used in a known, conventional manner by cutting off the tip. The metering nozzle has then typically a cylindrical or conical shape, i.e., a round cross-section. Within the context of the present invention, the metering nozzle can also have an oval, elliptical or polygonal cross-section. In addition, the tip of the nozzle head of the metering nozzle also can also be round or in form of a truncated cone. A corresponding design of the nozzle head tip enables more than only a single opening in the region of the tip.

According to a preferred embodiment, the openings are uniformly distributed on the jacket section in form of a ring. The angular spacing (α) of the openings is α=360°/n, depending on the number (n) of the openings.

In another embodiment, the openings are formed as multiple consecutive rings and are furthermore arranged with an offset.

Depending on the container, the dispensing adapter according to the invention is slipped on, clamped on or screwed on. For this purpose, the dispensing adapter has on the end opposite the tip either an interior thread or a contour which corresponds to a receiving portion of a screw or plug connection on the respective container.

With conventional dispensing adapters, the problem exists that an angle adjustment of maximally only 90°, in many instances of less than 45°, can be attained by rotating or pivoting the nozzle head, when an angle between the respective longitudinal axes of the adapter sections of <180° is desired.

Conversely, the high flexibility of the coupling members shaped as expansion bellows or articulated joints causes the nozzle head which is initially oriented in a desired position, to bounce back to its original position as a result of the pressure at which the dispensed material is ejected. However, a return of the nozzle head to its initial position must be prevented.

In another embodiment of the dispensing adapter according to the invention, a connecting tube is arranged on one end of the basic tube section at an angle of <180°, preferably <135°, which is connected with a conical metering nozzle by a ball joint. This results in an improved dispensing adapter, which is a flexible, easy to operate and inexpensive to manufacture.

According to a preferred embodiment, the connecting tube and the base tube section form an angle (α) of α=90° with one another.

The arrangement of the connecting tube on the base tube section at an angle (α) of α=90°, and the connection of the metering nozzle with the connecting tube via a ball joint allow the angle between the longitudinal axes of the base tube section and the longitudinal axes of the metering nozzle to be <90°. Preferably, an angle between 45° and 135° can be adjusted. This provides substantial flexibility in the orientation of the metering nozzle, so that areas which are difficult to reach, for example gaps between brickwork and door frame, can be easily accessed.

The arrangement of the connecting tube on the base tube section at an angle (α) of α=90° also changes the flow direction. The material to be dispensed is pressed in the direction of the longitudinal axis of the connecting tube where the adapter section of the connecting tube is connected to the base tube, thereby counteracting the tendency of the metering nozzle to return to the initial position.

According to a preferred embodiment described in the dependent claims, the ball joint has a partially spherical nipple which is overlapped by a hollow body matching the diameter of the partial sphere.

A high friction resistance between the partially spherical nipple and the matched hollow body prevents the oriented metering nozzle from suddenly returning to its original position parallel to the longitudinal axis of the connecting tube. However, if the friction resistance of the joint is too high, the joint becomes stiff and is difficult to operate.

In another preferred embodiment, or the partially spherical outer jacket of the nipple or the partially spherical inner wall of the hollow body of the ball joint include individual protuberances or grooves. This reduces the friction resistance while simultaneously optimizing frictional coupling.

The dispensing adapter is preferably made of plastic, and the individual parts are preferably manufactured by injection molding. The manufacturing costs then remain low, so that the dispensing adapter according to the invention can be offered for sale at a low price for single use.

To enable quick exchange of a spent dispensing adapter, the free end of the base tube section has an interior thread adapted to be screwed on the exterior thread of a commercially available cartridge, can or tube. An intermediate adapter is required if the thread diameters are different. In a preferred embodiment, the dispensing adapter of the invention can be connected with the provided dispensing adapter of a foam gun by using an adapter piece that can be placed over a tube section. Because of the provided adapter piece can remain on the foam gun, a commercially available foam gun can be quickly and easily retrofitted with a dispensing adapter according to the invention.

The material is dispensed by the dispensing adapter typically through an opening located at the tip of the nozzle head. The nozzle head either already has an opening or the user cuts off the front portion of the tip before use, whereby the user defines the size of the dispensing opening by suitably positioning the cut.

For areas which are located further back and therefore difficult to access, or for very deep gaps, the dispensing adapter is placed or screwed on a tubular or hose-like extension piece, which is in turn attached to the container.

With this embodiment, conventional dispensing adapters can also be retrofitted by sliding one of the afore-described dispensing adapters over the original dispensing adapter.

Because the connection between the dispensing adapter and the container can be easily released, the adapter can also be quickly and readily changed, so that if need arises, an adapter having openings arranged in a ring-shaped pattern can be exchanged against an adapter with a dome-shaped tip.

In the context of the present invention, the dispensing adapters or metering nozzles can also be curved, for example like the handle of an umbrella, so as to enable extreme angular positions of the nozzle head tip. According to the invention, a dispensing adapter of suitable shape and size having corresponding openings and/or rated break points can be contemplated for each application.

Exemplary embodiments of the invention are illustrated in the following drawings.

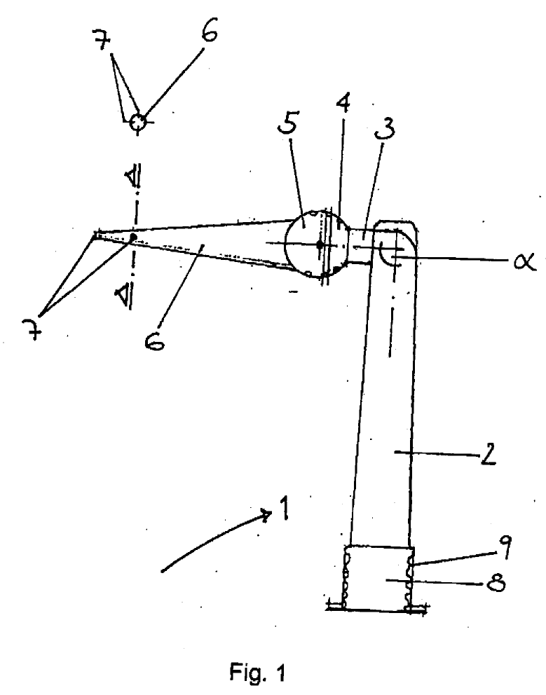

FIG. 1 shows a view of a dispensing adapter according to the invention, and a cross-section through the front section of the illustrated metering nozzle,

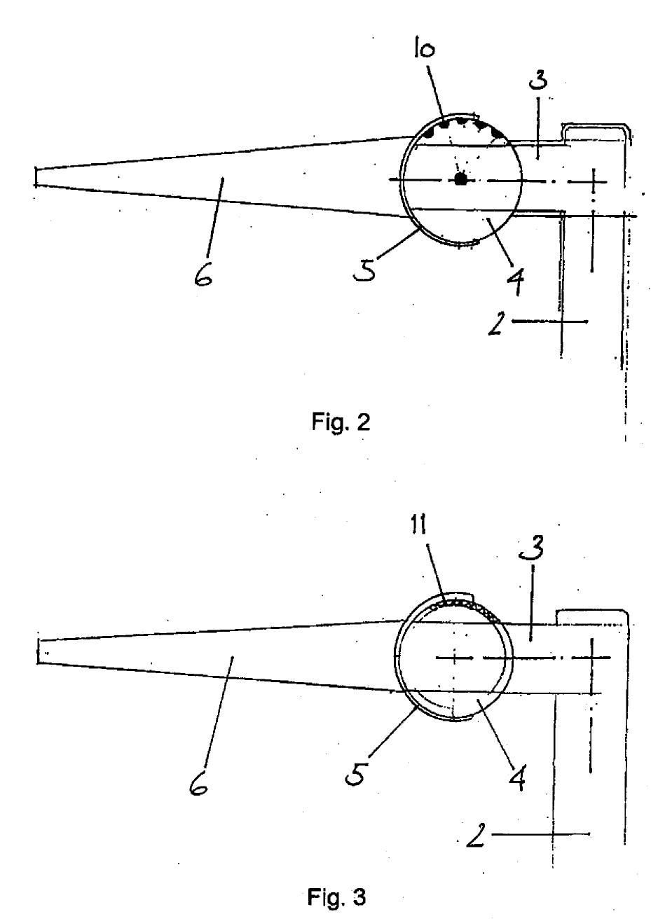

FIGS. 2 and 3 each show a partial cross-sectional view of a dispensing adapter according to the invention with different embodiments of the ball joint,

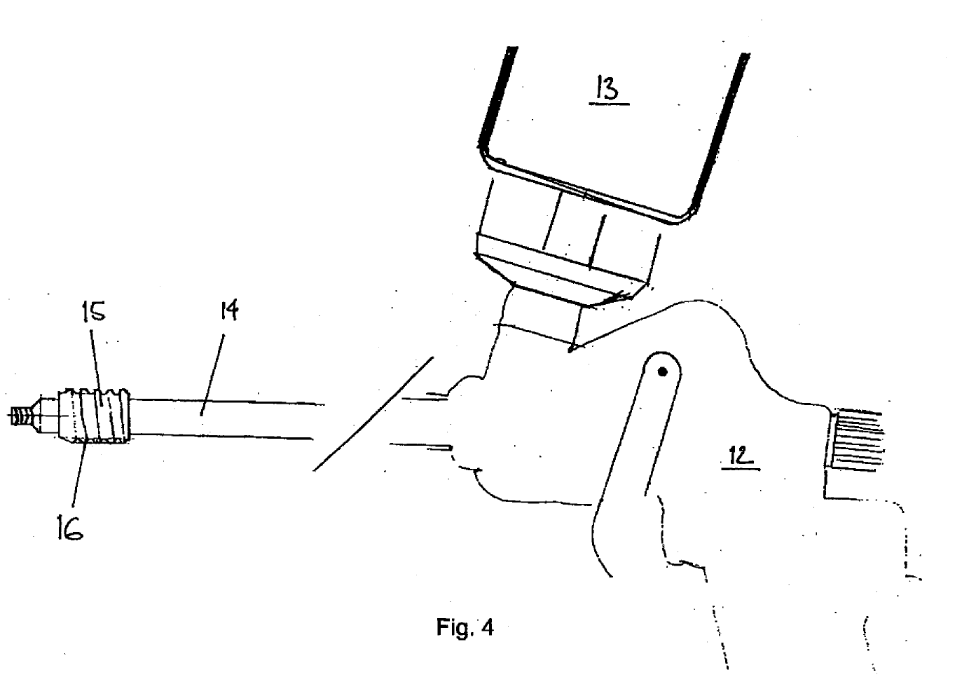

FIG. 4 shows a partial view of a commercially available foam gun with an applied adapter,

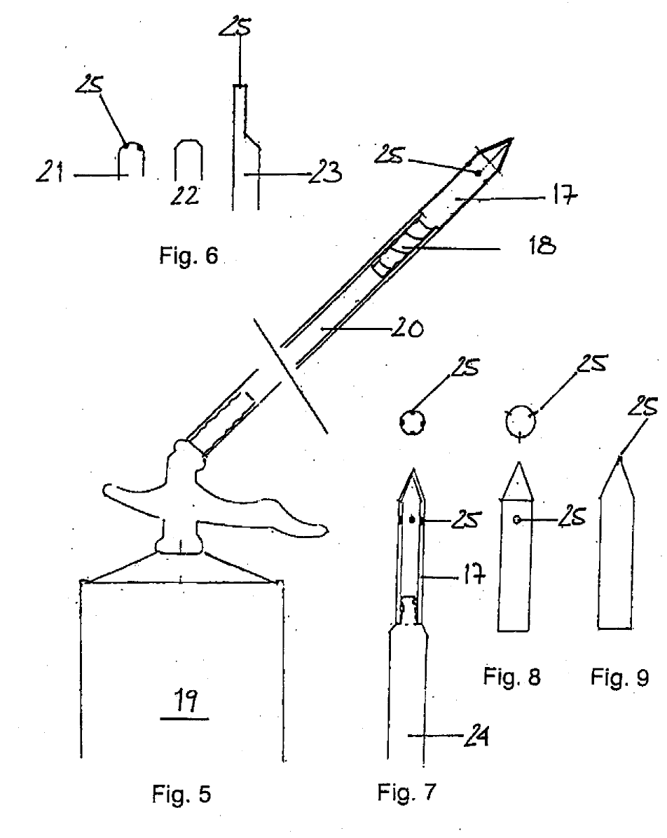

FIG. 5 shows a cross-sectional view of a foam gun with a hose extension and a dispensing adapter according to the invention,

FIG. 6 shows three views of different embodiments of the nozzle head,

FIG. 7 shows a longitudinal section through a container with the dispensing adapter according to the invention, and at the top a schematic cross-section,

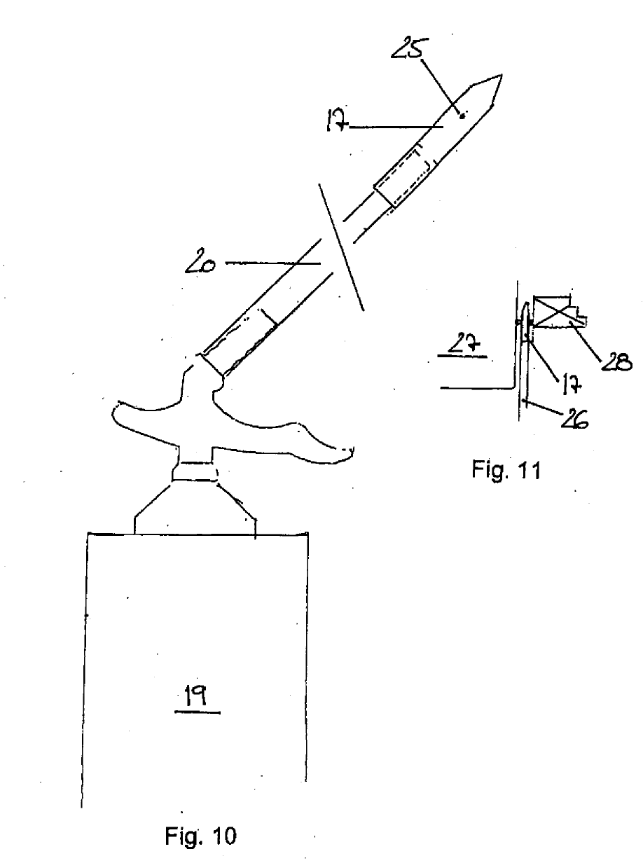

FIG. 9 shows a view of a dispensing adapter,

FIG. 10 shows a partial view of a foam gun with a hose extension and a dispensing adapter according to the invention, and

FIG. 11 shows use of a dispensing adapter according to FIG. 10.

The dispensing adapter 1 illustrated in FIG. 1 has a base tube section 2 with a slight conical taper, followed by a cylindrical connecting tube 3 at an angle (α), α=90°. The cylindrical connecting tube 3 has a partially spherical nipple 4, which is overlapped by a hollow body 5 matching the diameter of the partial sphere and which forms in conjunction with the nipple 4 a ball joint. The hollow body 5 which matches the diameter of the partial sphere is a component of a conical metering nozzle 6. For dispensing the material, the metering nozzle 6 has an opening 7 at the tip, as well as four uniformly spaced-apart lateral openings 7, as schematically illustrated in the cross-sectional view of FIG. 1. The diameter of the openings 7 is 2 mm.

The free end of the base tube 2 has a socket-like cylindrical section 8 with an interior thread 9. The dispensing adapter 1 can be screwed with the interior thread 9 on the exterior thread of a container (not shown) or an adapter 15.

FIGS. 2 and 3 show different embodiments of the ball joint which connects the metering nozzle 6 with the connecting tube 3.

FIG. 2 shows a ball joint made of a partially spherical nipple 4 and an overlapping hollow body 5 matching the diameter of the partial sphere, wherein the partially spherical exterior jacket of the nipple 4 has individual protuberances 10.

The design of the ball joint illustrated in FIG. 3 is different from the embodiment illustrated in FIG. 2 in that the partially spherical nipple 4 has individual grooves 11 instead of the protuberances 10.

FIG. 4 shows in a partial view a commercially available foam gun 12 with an attached foam can 13, as well as a tube section 14 connected with the foam gun and supporting an adapter 15. The adapter 15 has an exterior thread 16 which matches the interior thread 9 of the dispensing adapter 1 according to the invention, as depicted in FIG. 1. The dispensing adapter according to the invention can therefore be readily placed on a commercially available foam gun.

The dispensing adapter 17 depicted in FIG. 5 has a cylindrical and a conical section. The lower region of the cylindrical section includes an exterior thread 18, which can be used to insert the dispensing adapter 17 in a hose 20 which is in turn connected with a foam gun 19. According to the invention, the dispensing adapter has openings 25 which are arranged in the nozzle head in a ring pattern and uniformly distributed on the cylindrical upper section. The diameter of the cylindrical section of the adapter is 8 mm, the diameter of the punch-outs or openings about 3 mm.

FIG. 6 shows three different exemplary designs of the nozzle head. Instead of the conical section according to FIG. 5, the tip can also be round 21, formed as a truncated cone 22 or as a finger 23. With the shape 21, the openings 25 are distributed over the dome-shaped curvature, and/or with the shape 23, the front nozzle head tip has a single opening.

FIG. 7 shows a dispensing adapter 17 with an interior thread which is screwed onto a container 24. The cylindrical jacket piece of the nozzle head has four punch-outs 25 or openings, through which the material residing in the container 24 is discharged. As seen from the cross-section, the four openings are distributed in an arrangement with equal spacing between openings. Instead of the four openings distributed in a ring pattern, three openings according to FIG. 8 and/or a single opening in the nozzle head tip according to FIG. 9 can be provided.

FIG. 11 shows the use of a foam gun depicted in FIG. 10 with a dispensing adapter 17 according to the invention. The hose extension 20 and the narrow shape of the dispensing adapter 17 allow the nozzle had 26 to reach even narrow gaps in the back, for example, in the illustrated situation, the gap between a wall 27 and the frame of a window 28.

The dispensing adapters 17 according to the invention depicted in FIGS. 5 to 11 can also be used on connecting hoses without a ball joint.

It has been demonstrated that with a nozzle head having a round tip 21 and only lateral openings 7, 25, the foam sealant attains a high viscosity and the sealing compound has a comparably high density resembling that of Styrofoam. The openings 7, 25 hereby have advantageously different sizes. With this embodiment, excellent mixing of the sealant in the nozzle can be achieved.

### REFERENCE SYMBOLS

1 Dispensing adapter

2 Base tube

3 Connecting tube

4 Partially spherical nipple

5 Hollow body

6 Metering nozzle

7 Opening

8 Socket-like section

9 Interior thread

10 Protuberances

11 Grooves

12 Foam gun

13 Foam can

14 Tube section

15 Adapter

16 Exterior thread

17 Dispensing adapter

18 Exterior thread

19 Foam gun

20 Hose

21 Round tip

22 Tip shaped as a truncated cone

23 Finger-shaped tip

24 Container

25 Opening, punch-out

26 Nozzle head

27 Wall

28 Window

1. A dispensing adapter for cartridges, cans or tubes for storing and dispensing of highly viscous materials comprising a metering nozzle with a nozzle head, wherein the nozzle head of the metering nozzle comprises several spaced-apart openings for discharging the material.

2. The dispensing adapter of claim 1, wherein the openings are formed by selectively punching out initially closed rated break points.

3. The dispensing adapter of claim 1, wherein the openings are arranged in a conical or cylindrical jacket member of the metering nozzle.

4. The dispensing adapter according to claim 3, wherein the spaced-apart openings are arranged laterally in the nozzle head in form of a ring with an angular spacing between the lateral openings of B:=360°/n, wherein (n) is the number of openings.

5. The dispensing adapter of claim 1 wherein the openings are formed in different sizes or shapes, or both.

6. The dispensing adapter of claim 1 wherein the openings have a cross-section selected from round, elliptical, oval, triangular, rectangular and rhombic.

7. The dispensing adapter of claim 4, wherein the openings are uniformly distributed on the cylindrical upper section of the metering nozzle.

8. The dispensing adapter of claim 3, wherein the spaced-apart openings are arranged laterally in the nozzle head in form of multiple consecutive rings, and wherein the openings located on different rings are offset with respect to one another.

9. The dispensing adapter of claim 1 wherein the nozzle head comprises a tip having a shape selected from round, truncated cone, and finger-shaped.

10. The dispensing adapter of claim 9, wherein the round tip has a dome-shaped curvature and the openings are distributed over the dome-shaped curvature.

11. The dispensing adapter of claim 1, further comprising a base tube section having a first end adapted for attachment to a cartridge, can or tube, and a second end connected to a connecting tube at an angle <180°, wherein the connecting tube is connected with the metering nozzle via a ball joint and the metering nozzle has a conical shape.

12. The dispensing adapter according to claim 11, wherein the second end is connected to the connecting tube at an angle α=90°.

13. The dispensing adapter of claim 11, wherein the ball joint includes a partly spherical nipple and a hollow body overlapping the nipple, with an inside diameter of the hollow body matching an outside diameter of the partial sphere, wherein an outer surface of the nipple or an inner wall of the hollow body includes individual protuberances or grooves.

14. The dispensing adapter of claim 11, wherein the first end of the base tube section includes an interior thread which is configured for screw-attachment on a cartridge, can or tube.

15. The dispensing adapter of claim 1, wherein the dispensing adapter is entirely made of plastic.

16. The dispensing adapter of claim 9, wherein the finger-shaped tip has a single opening at a forward end of the tip.

17. The dispensing adapter of claim 11, wherein the second end is connected to the connecting tube at an angle <135°.

18. The dispensing adapter of claim 11, wherein the first end of the base tube section includes an interior thread, and further comprising an adapter having an exterior thread threadingly connectable to the interior thread of the base tube section, said adapter connectable with a dispensing adapter of a foam gun.

19. The dispensing adapter of claim 18, further comprising a tube section interposed between the adapter and the dispensing adapter of the foam gun.

20. The dispensing adapter of claim 15, comprising injection-molded parts.
